(19) United States
(12) Patent Application Publication
(10) Pub. No.: US 2026/0308971 A1
(43) Pub. Date: Oct. 8, 2026

(54) APPARATUS AND METHOD FOR CONTROLLING CLOSING FORCE OF AUTOMATIC VEHICLE OPENING AND CLOSING SYSTEM

(71) Applicants: Hyundai Motor Company, Seoul (KR); Kia Corporation, Seoul (KR)

(72) Inventors: Yong Hyuck IM, Hwaseong-Si (KR); Sang Wook LEE, Hwaseong-Si (KR); Ji Ho CHOI, Hwaseong-Si (KR); Jun Hyuk KIM, Hwaseong-Si (KR)

(21) Appl. No.: 19/346,698

(22) Filed: Oct. 1, 2025

(30) Foreign Application Priority Data
Apr. 7, 2025 (KR) 10-2025-0044481

(51) Int. Cl. E05F 15/75; B60J 10/84

(52) U.S. Cl. CPC E05F 15/75; B60J 10/84; E05Y 2900/548

(57) ABSTRACT

An apparatus for controlling closing force of an automatic vehicle opening and closing system includes a motor unit providing power to a driving unit and a power latch for opening and closing a vehicle closure, a weather strip applying reaction force in a direction opposite to a direction in which the vehicle closure is closed when the vehicle closure is located in a predetermined section, a current detection unit detecting current consumption of the motor unit in real time, and a controller controlling the motor unit so that closing force generated by the power is applied in the direction in which the vehicle closure is closed, wherein a magnitude of the closing force is changed from an initial value, and the motor unit includes a motor of the driving unit and a motor of the power latch.

### CROSS-REFERENCE TO RELATED APPLICATION(S)

This application claims benefit of priority to Korean Patent Application No. 10-2025-0044481 filed on Apr. 7, 2025 in the Korean Intellectual Property Office, the disclosure of which is incorporated herein by reference in its entirety.

### TECHNICAL FIELD

The present disclosure relates to an apparatus and method for controlling closing force of an automatic vehicle opening and closing system, and more particularly, to an apparatus and method for controlling closing force of an automatic vehicle opening and closing system capable of changing the magnitude of closing force as the magnitude of reaction force changes due to a weather strip.

### BACKGROUND

The matters described in this Background section are only for enhancement of understanding of the background of the disclosure, and should not be taken as acknowledgment that they correspond to prior art already known to those skilled in the art.

When a motor operates to electrically close a vehicle closure, closing force generated by the motor overcomes reaction force of a weather strip and a power latch may perform locking and close the vehicle closure. However, when electrically closing the vehicle closure, if the magnitude of closing force is small compared to the magnitude of reaction force of the weather strip, a quality problem may occur in which the vehicle closure is not closed or not completely closed, so the magnitude of closing force is fixed to a value higher than the magnitude of reaction force, which leads to a problem in that the magnitude of closing force may not change even if the magnitude of reaction force is changed. In addition, since reaction force of the weather strip part may be different for each vehicle and the closing force, force required for closing, may be different, depending on the quality of the vehicle body, a mass production technology may set the magnitude of closing force to be high, compared to the actual use conditions in order to prevent a decrease in production rates of the factories or increases the magnitude of closing force in the production stage compared to the development stage, and thus, there may be a problem that fatal injury may occur if a human body is caught between the vehicle closure and the weather strip due to the high magnitude of closing force.

Therefore, an apparatus and method for controlling closing force of an automatic vehicle opening and closing system that may solve the above-described problems is considered.

### SUMMARY

An example of the present disclosure is to provide an apparatus and method for controlling closing force of an automatic vehicle opening and closing system.

Another example of the present disclosure is to minimize injury to the human body when closing a vehicle closure by changing the magnitude of closing force as the magnitude of reaction force due to the weather strip is changed, thereby improving safety performance.

Another example of the present disclosure is to enable a vehicle closure to be automatically closed by setting the magnitude of closing force to be higher than the magnitude of reaction force, even when the magnitude of closing force is changed as the magnitude of reaction force due to a weather strip is changed.

The purpose of the present disclosure is not limited to the purpose mentioned above, and other purposes not mentioned may be clearly understood by those skilled in the art to which the present disclosure pertains from the description below.

According to the present disclosure, an apparatus of a vehicle, the apparatus may comprise a motor assembly including a motor of a closure actuator assembly and a motor of a power latch, wherein the motor assembly is configured to provide power to the motor of the closure actuator assembly and the motor of the power latch for opening and closing a vehicle closure of the vehicle, a weather strip configured to, based on the vehicle closure being located in a predetermined section, cause a reaction force in a direction opposite to a direction of a closing force, wherein the closing force is a force by which the vehicle closure is closed, a current sensor configured to detect current consumption of the motor assembly in real time, and a controller circuit configured to, based on the detected current consumption, adjust a magnitude of the closing force from an initial value, and control the motor assembly to apply the adjusted magnitude of the closing force in a direction in which the vehicle closure is closed.

The apparatus, wherein the controller circuit is configured to control the motor assembly so that the magnitude of the closing force is changed from the initial value to a first value based on, the vehicle closure being located in the predetermined section in a process in which the vehicle closure is closed N times, where N is a natural number, and a maximum value of a current consumption value of the motor of the closure actuator assembly being within a first driving reference current range for N times, wherein the current consumption value of the motor of the closure actuator assembly is measured N times in real time by the current sensor, and wherein the first value has a magnitude of force lower than the initial value.

The apparatus, wherein the controller circuit is configured to control the motor assembly so that the magnitude of the closing force is changed from the first value to a second value based on, the vehicle closure being located in the predetermined section in a process in which the vehicle closure is closed N times, and the maximum value of the current consumption value of the motor of the closure actuator assembly being within a second driving reference current range for N times, wherein the second value has a magnitude of force lower than the first value, and wherein an upper limit value and a lower limit value of the second driving reference current range are smaller than an upper limit value and a lower limit value of the first driving reference current range, respectively.

The apparatus, wherein the controller circuit is configured to control the motor assembly so that the magnitude of the closing force is changed from the initial value to a first value based on, the vehicle closure being located in the predetermined section in a process in which the vehicle closure is closed N times, where N is a natural number, and a maximum value of a current consumption value of the motor of the power latch being within a first power latch reference current range for N times, wherein the current consumption value of the motor of the power latch is measured N times in real time by the current sensor, and wherein the first value has a magnitude of force lower than the initial value.

The apparatus, wherein the controller circuit is configured to control the motor assembly so that the magnitude of the closing force is changed from the first value to a second value based on, the vehicle closure being located in the predetermined section in a process in which the vehicle closure is closed N times, and the maximum value of the current consumption value of the motor of the power latch being within a second power latch reference current range for N times, wherein the second value has a magnitude of force lower than the first value, and wherein an upper limit value and a lower limit value of the second power latch reference current range are smaller than an upper limit value and a lower limit value of the first power latch reference current range, respectively.

The apparatus, wherein the controller circuit configured to control the motor assembly so that the magnitude of the closing force is changed from the initial value to a first value based on, the vehicle closure being located in the predetermined section in a process in which the vehicle closure is closed N times, where N is a natural number, a maximum value of a current consumption value of the motor of the closure actuator assembly being within a first driving reference current range for N times, wherein the current consumption value of the motor of the closure actuator assembly is measured N times in real time by the current sensor, and a maximum value of a current consumption value of the motor of the power latch being within a first power latch reference current range for N times, wherein the current consumption value of the motor of the power latch is measured N times in real time by the current sensor, and wherein the first value has a magnitude of force lower than the initial value.

The apparatus, wherein the controller circuit configured to control the motor assembly so that the magnitude of the closing force is changed from the first value to a second value based on, the vehicle closure being located in the predetermined section in a process in which the vehicle closure is closed N times, the maximum value of the current consumption value of the motor of the closure actuator assembly being within a second driving reference current range for N times, and the maximum value of the current consumption value of the motor of the power latch being within a second power latch reference current range for N times, wherein the second value has a magnitude of force lower than the first value, wherein an upper limit value and a lower limit value of the second driving reference current range are each smaller than a corresponding upper limit value and a corresponding lower limit value of the first driving reference current range, and wherein an upper limit value and a lower limit value of the second power latch reference current range are smaller than an upper limit value and a lower limit value of the first power latch reference current range, respectively.

The apparatus, wherein the vehicle closure may comprise at least one of a door of the vehicle, a tailgate of the vehicle, or a trunk of the vehicle.

The apparatus, wherein the predetermined section is a section in which the vehicle closure starts to contact the weather strip and the reaction force caused by the weather strip to the vehicle closure is generated.

The apparatus, wherein the controller circuit is configured to control the motor assembly so that the magnitude of the closing force is changed to the initial value when the weather strip is replaced.

According to the present disclosure, a method performed by an apparatus of a vehicle, the method may comprise providing power to a motor of a closure actuator assembly and a motor of a power latch by a motor assembly for opening and closing a vehicle closure of the vehicle, based on the vehicle closure being located in a predetermined section, causing, by a weather strip of the vehicle, reaction force in a direction opposite to a direction of a closing force, wherein the closing force is a force by which the vehicle closure is closed, detecting current consumption of the motor assembly in real time, based on the detected current consumption, adjusting a magnitude of the closing force from an initial value, and controlling the motor assembly to apply the adjusted magnitude of the closing force in a direction in which the vehicle closure is closed.

According to the present disclosure, a vehicle may comprise a closure panel configured to move between an open position and a closed position, a motor configured to provide closing force for closing the closure panel, a power latch configured to secure the closure panel in the closed position, a weather strip configured to contact the closure panel in the closed position and cause a reaction force opposing closure of the closure panel, a processor, and a memory storing at least one instruction that, when executed by the processor communicating with the memory, is configured to cause the vehicle to, detect a current level of the motor corresponding to the reaction force caused by the weather strip opposing closure of the closure panel, determine a maximum value of the detected current level over a predetermined number of consecutive closure panel closing events, based on the maximum value repeatedly falling within a reference current range for the predetermined number of consecutive closure panel closing events, adjust a magnitude of the closing force of the motor.

The vehicle, wherein the at least one instruction, when executed by the processor communicating with the memory, is configured to cause the vehicle to determine the current level of the motor at a time of initial locking of the power latch during a closure panel closing event, and use the determined current level as the maximum value.

The vehicle, wherein the at least one instruction, when executed by the processor communicating with the memory, is configured to cause the vehicle to change the magnitude of the closing force from an initial value to a first value, and from the first value to a second value lower than the first value, based on the maximum value being repeatedly within respective lower reference current ranges for the predetermined number of consecutive closure panel closing events.

### BRIEF DESCRIPTION OF DRAWINGS

The and other examples, features, and advantages of the present disclosure will be more clearly understood from the following detailed description, taken in conjunction with the accompanying drawings, in which:

FIG. 1 shows an example of an apparatus for controlling closing force of an automatic vehicle opening and closing system;

FIG. 2 shows an example of a motor unit;

FIG. 3 shows an example of a section in which reaction force due to a weather strip is applied to a vehicle closure;

FIG. 4 shows exemplary magnitudes of closing force and reaction force of an automatic vehicle opening and closing system;

FIG. 5 shows an example of a change in the current consumption of a motor of a driving unit;

FIG. 6 shows an example of a criterion for changing closing force by a controller;

FIG. 7 shows an example of a change in RPM of a motor of a driving unit;

FIG. 8 shows an example of a change in duty ratio of a motor of a driving unit;

FIG. 9 shows an example of a method for controlling closing force of an automatic vehicle opening and closing system; and

FIG. 10 shows an example of an operation of controlling a motor unit.

FIG. 11 shows an example computing system.

### DETAILED DESCRIPTION

While the present disclosure may be modified in various ways and take on various alternative forms, specific examples thereof are shown in the drawings and described in detail below. However, it should be understood that there is no intent to limit the present disclosure to the particular forms disclosed, but on the contrary, the present disclosure covers all modifications, equivalents, and alternatives falling within the spirit and scope of the present disclosure.

It will be understood that, although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of one or more of the associated listed items.

The terms, such as “unit, part, portion, etc.” may be used to describe various components, but the components should not be limited by these terms. The terms may refer to not only physically/visually distinct components, but also to functions or components of a portion even if the corresponding portion is not clearly divided.

The terms used herein to describe examples of the present disclosure are not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different way, all the terms used herein including technical and scientific terms have the same meanings as understood by those skilled in the art to which the present disclosure pertains. Such terms as defined in generally used dictionaries should be construed to have the same meanings as those of the contexts of the related art, and unless clearly defined in the application, they should not be construed to have ideally or excessively formal meanings.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

The disclosure relates to an apparatus and method for adaptively controlling a closing force in an automatic vehicle opening and closing system. The closing force is the motor-applied force that counteracts a reaction force of a weather strip when the vehicle closure contacts the weather strip during closing. A motor assembly drives the closure through a closure actuator assembly and a power latch, while a current sensor measures motor current of the motor assembly in real time. A controller compares measured currents over repeated closings to predetermined reference ranges and adjusts the closing force in steps when lower reaction forces are detected, thereby reducing injury risk (e.g., if something like a hand is in the way of closing) while maintaining reliable closure. When the weather strip is replaced, the closing force is reset to an initial value.

Examples of the present disclosure are described in detail with reference to the accompanying drawings.

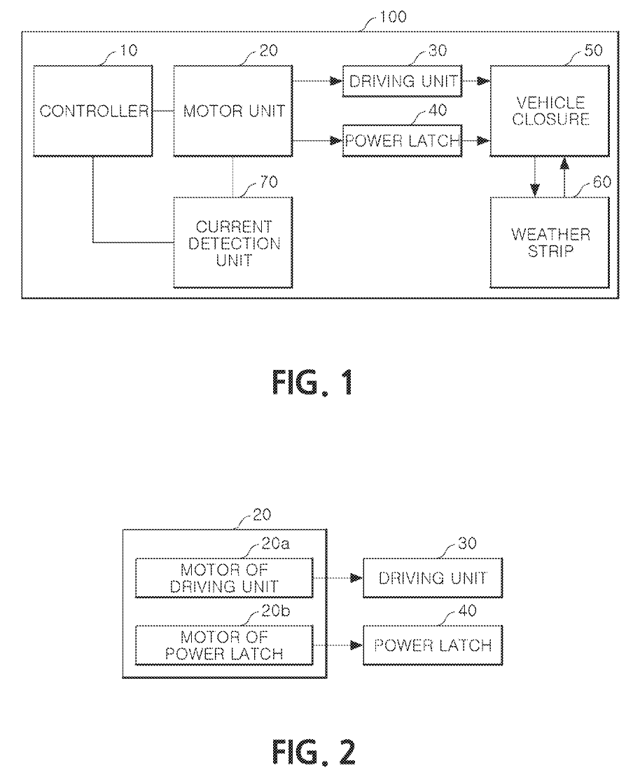

FIG. 1 shows an example of an apparatus for controlling closing force of an automatic vehicle opening and closing system according to an example of the present disclosure.

As illustrated in FIG. 1, the automatic vehicle opening and closing system 100 may include a controller 10, a motor unit 20, a driving unit 30, a power latch 40, a vehicle closure 50, a weather strip 60, and a current detection unit 70. However, the present disclosure is not limited thereto, and additional components (e.g., position sensors, limit switches, damping units, or wireless control modules, etc.) not illustrated may be included.

In the description of an example of the present disclosure, closing force may refer to force applied by the motor unit 20 in a direction in which the vehicle closure 50 is closed in order to electrically close the vehicle closure 50 (e.g., when automatically shutting a tailgate, trunk, or sliding door, etc.). In FIG. 1, the arrows indicate directions in which force is transmitted.

The vehicle closure 50 may include a trunk, a tailgate, and a door, and according to an example, the vehicle closure 50 may be a trunk (e.g., a sedan trunk lid, an SUV tailgate, or a minivan sliding door, etc.).

The motor unit 20 is a device providing power for the vehicle closure 50 to be electrically closes, and power may be provided to the driving unit 30 and the power latch 40 by the motor unit 20 (e.g., via direct gear connection, belt drive, or chain drive, etc.).

The driving unit 30 and the power latch 40 may receive power from the motor unit 20 and apply closing force to the vehicle closure 50 in the direction in which the vehicle closure 50 is closed. According to an example, closing force may be applied in the direction in which the trunk is closed from a state in which the trunk is completely opened by the driving unit 30 to an initial locking of the power latch 40, and closing force may be applied to the vehicle closure 50 by the power latch 40 to completely close the vehicle closure 50 and secure the vehicle closure 50 to the vehicle body. The trunk is finally locked by the power latch 40, and the closed state of the trunk may be maintained (e.g., even during vehicle vibration, sudden braking, or minor impacts, etc.).

The weather strip 60 is located between the vehicle closure 50 and the vehicle body but is attached to the vehicle body, and air, water, and noise introduced from the outside may be blocked by the weather strip 60 (e.g., road noise, rainwater, or dust infiltration, etc.).

In addition, from the moment the vehicle closure 50 touches the weather strip 60 until the vehicle closure 50 is finally closed, reaction force may be applied to the vehicle closure 50 by the weather strip 60, and reaction force caused by the weather strip 60 may be a force generated as the weather strip 60 is compressed in the process of the vehicle closure 50 being closed by closing force. A material of the weather strip 60 may be ethylene propylene diene monomer (EPDM) or thermoplastic elastomer (TPE) but is not limited thereto (e.g., silicone rubber, PVC-based elastomers, or natural rubber blends, etc.).

EPDM is synthetic rubber made by mixing ethylene, propylene, and diene monomers, has excellent weather resistance, heat resistance, and ozone resistance, etc., and may be used as a weather strip 60 for a vehicle (e.g., to maintain elasticity in cold climates or resist degradation under UV exposure, etc.).

TPE is a thermoplastic elastomer, a material that is flexible like rubber but may be processed like a thermoplastic material, and has flexibility and elasticity, so TPE may be used as a weather strip 60 for a vehicle (e.g., for weight reduction, ease of recycling, or integration with rigid plastic trim, etc.).

The controller 10 controls the motor unit 20 to apply closing force generated by the power provided by the motor unit 20 to the vehicle closure 50, or the motor unit 20 may be controlled by the controller 10 so that the magnitude of closing force may be changed (e.g., increasing the force in cold weather to compensate for hardened seals, or decreasing the force when detecting low resistance, etc.).

The current detection unit 70 detects current consumption of the motor unit 20 in real time, so that a value of the current consumption of the motor unit 20 detected by the current detection unit 70 may be provided to the controller 10 (e.g., to identify obstructions, monitor seal compression, or adjust motor torque, etc.).

FIG. 2 shows an example of the motor unit according to an example of the present disclosure.

As illustrated in FIG. 2, the motor unit 20 may include a motor 20a of the driving unit and a motor 20b of the power latch. According to an example, the motor 20a of the driving unit may provide power to the driving unit 30, and the motor 20b of the power latch may provide power to the power latch 40 (e.g., via a gear train, worm gear, or belt drive, etc.).

In FIG. 2, the motor 20a of the driving unit and the motor 20b of the power latch are illustrated as being included in the motor unit 20 for the purpose of describing the present disclosure, but according to an example, the motor 20a of the driving unit may be included in the driving unit 30, and the motor 20b of the power latch may be included in the power latch 40 (e.g., as integrated subassemblies for ease of manufacturing or maintenance, etc.).

Referring to FIGS. 2 together with 1, current consumption of the motor unit 20 detected by the current detection unit 70 may include current consumption of the motor 20a of the driving unit (e.g., a closure actuator assembly) and current consumption of the motor 20b of the power latch (e.g., measured separately for diagnostic purposes or combined to determine total system load, etc.).

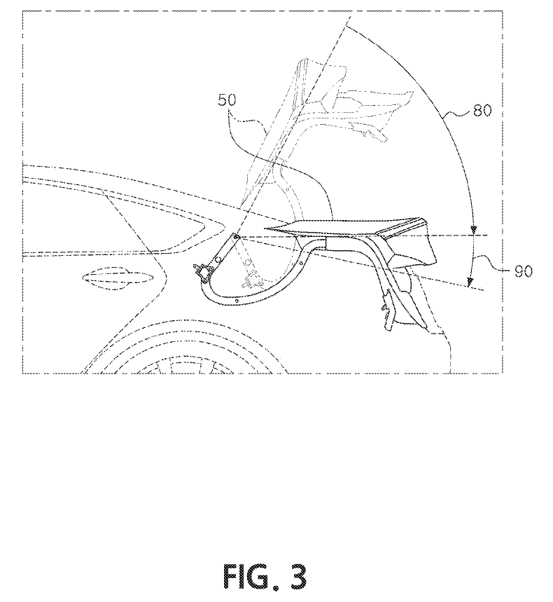

FIG. 3 shows an example of a section in which reaction force due to a weather strip is applied to a vehicle closure according to an example of the present disclosure (e.g., during trunk closing, door sealing, or tailgate latching, etc.).

As illustrated in FIG. 3, the process of closing a vehicle closure 50 in an automatic vehicle opening and closing system 100 may be divided into a section 80 without reaction force due to the weather strip and a section 90 with reaction force due to the weather strip (e.g., a pre-contact travel section and a seal-compression section, etc.).

The section 80 without reaction force due to the weather strip may be a section from the moment when the vehicle closure 50 starts to be closed to before the vehicle closure 50 comes into contact with the weather strip 60. In the section 80 without reaction force due to the weather strip, closing force for closing the vehicle closure 50 may be applied to the vehicle closure 50 in the direction in which the vehicle closure 50 is closed (e.g., driven solely by the motor without seal compression, allowing faster travel and lower current draw, etc.).

The section 90 with reaction force due to the weather strip may be a section from the moment when the vehicle closure 50 starts to contact the weather strip 60 until complete locking of the vehicle closure 50 is performed. Here, from the moment when the vehicle closure 50 starts to contact the weather strip 60, the weather strip 60 is compressed, reaction force due to the weather strip 60 is generated, so that reaction force due to the weather strip 60 may be applied to the vehicle closure 50 in the opposite direction to the direction in which the vehicle closure 50 is closed, and closing force for closing the vehicle closure 50 may be applied to the vehicle closure 50 in the direction in which the vehicle closure 50 is closed (e.g., overcoming seal compression for watertight closure, compensating for temperature-stiffened materials, or ensuring proper latch engagement, etc.).

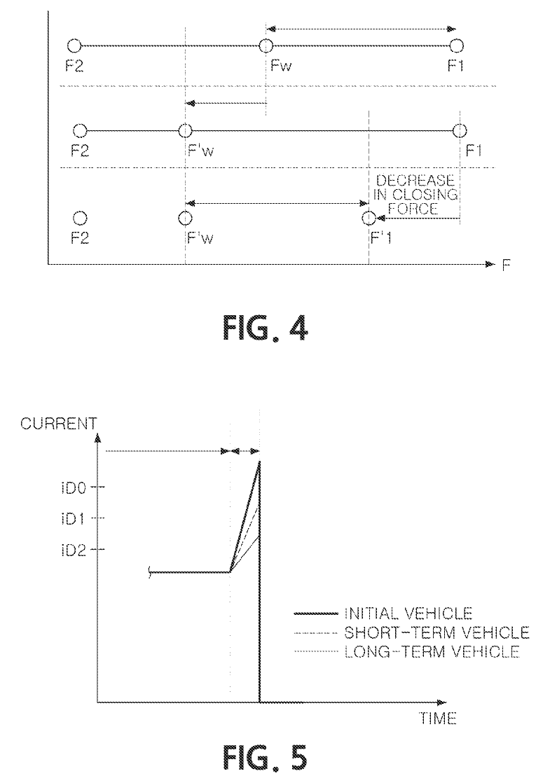

FIG. 4 is a diagram illustrating the magnitude of reaction force and closing force of the automatic vehicle opening and closing system according to an example of the present disclosure.

In FIG. 4, the X-axis (a horizontal axis) may refer to the magnitude of closing force and reaction force (e.g., measured in Newtons, kilograms-force, or pounds-force, etc.). Fw and F'w may refer to reaction force due to the weather strip 60, and F1, F2, and F'1 may refer to closing force.

Referring to FIGS. 4 together with 3, F2 may refer to closing force of the section 80 without reaction force due to the weather strip, and F1 and F'1 may refer to closing force of the section 90 with reaction force due to the weather strip (e.g., during seal compression, latch engagement, or secondary locking, etc.).

According to an example, the magnitude of F1 may be set to a value greater than the magnitude of F2. The magnitude of F2 may be set to a smaller value than the magnitude of Fw, but if the magnitude of F1 is smaller than the magnitude of Fw, the vehicle closure 50 may not be closed. Accordingly, the magnitude of F1 may be set to a larger value than the magnitude of Fw so that the vehicle closure 50 may be closed (e.g., ensuring sufficient sealing, proper latch operation, or compliance with water-leak prevention standards, etc.).

The magnitude of reaction force due to the weather strip 60 may vary depending on the deterioration of the weather strip 60 and quality of a vehicle body of the vehicle, but is not necessarily limited thereto. According to an example, if the weather strip 60 is formed of EPDM, the magnitude of reaction force may be reduced by 30% when the vehicle closure is left in a closed state for 70 hours (e.g., due to material compression set, loss of elasticity, or deformation from prolonged pressure, etc.).

As illustrated in FIG. 4, the magnitude of reaction force of Fw may be reduced to F'w due to the deterioration of the weather strip 60 and a difference in the quality of the vehicle body of the vehicle (e.g., uneven frame alignment, hinge wear, or assembly tolerances, etc.). For example, in the related art automatic vehicle opening and closing system 100, the magnitude of F1 is fixed, so that when the magnitude of reaction force is reduced to F'w, fatal injury may occur if a human body was caught between the vehicle closure 50 and the weather strip 60 due to the high closing force compared to reaction force. In order to minimize this problem, the apparatus for controlling closing force of the automatic vehicle opening and closing system 100 according to an example may change the magnitude of closing force by changing F1 to F'1 when the magnitude of reaction force due to the weather strip 60 is reduced (e.g., by lowering motor torque output, adjusting closing speed, or modifying control algorithms, etc.). Details thereof will be described with reference to FIGS. 5 to 8 below.

FIG. 5 shows an example of a change in current consumption of the motor of the driving unit according to an example of the present disclosure (e.g., under different seal conditions, environmental temperatures, or closure speeds, etc.).

In FIG. 5, the X-axis (the horizontal axis) may represent time in seconds (s). The Y-axis (a vertical axis) may represent the magnitude of current (I), with the unit being ampere (A). In addition, iD0, iD1, and iD2 indicated on the Y-axis (the vertical axis) may represent reference currents, respectively. The reference currents may be values set to define a reference current section (e.g., a threshold current range for triggering torque adjustments or safety interventions, etc.) to be described below.

Each graph illustrated in FIG. 5 may represent a change in the magnitude of the current consumed by the motor 20a of the driving unit included in the apparatus for controlling closing force of an automatic vehicle opening and closing system according to an example of the present disclosure over time (e.g., from the start of panel movement to final latch engagement, etc.).

The section in which the magnitude of the current changes may be the section 90 with reaction force due to the weather strip, and the section prior to entering the section in which the magnitude of the current changes may be the section 80 without reaction force due to the weather strip (e.g., free-travel movement without significant sealing resistance, etc.).

As shown in FIG. 5, when the vehicle closure 50 enters the section 90 with reaction force due to the weather strip, the magnitude of current consumed by the motor 20a of the driving unit may gradually increase until the initial locking of the power latch 40 in order to overcome reaction force of the weather strip 60 and close the vehicle closure 50 (e.g., progressively ramping torque to avoid abrupt impact, etc.). In addition, as the weather strip 60 is used for a long period of time, the magnitude of reaction force may decrease, and accordingly, the magnitude of current consumed by the motor 20a of the driving unit to overcome reaction force of the weather strip 60 may decrease (e.g., requiring recalibration of motor control parameters, etc.).

According to an example, among the initial vehicles, short-term vehicles, and long-term vehicles with the same vehicle type but different vehicle usage periods, the weather strip 60 of the initial vehicle may apply stronger reaction force to the vehicle closure 50 than the weather strip 60 of the short-term vehicles and long-term vehicles (e.g., due to minimal compression set or wear). Accordingly, the magnitude of current consumption at the time of initial locking of the power latch 40 of the initial vehicle may be the largest, and the amount of change in the current consumption until the initial locking of the power latch 40 of the initial vehicle may also be the largest.

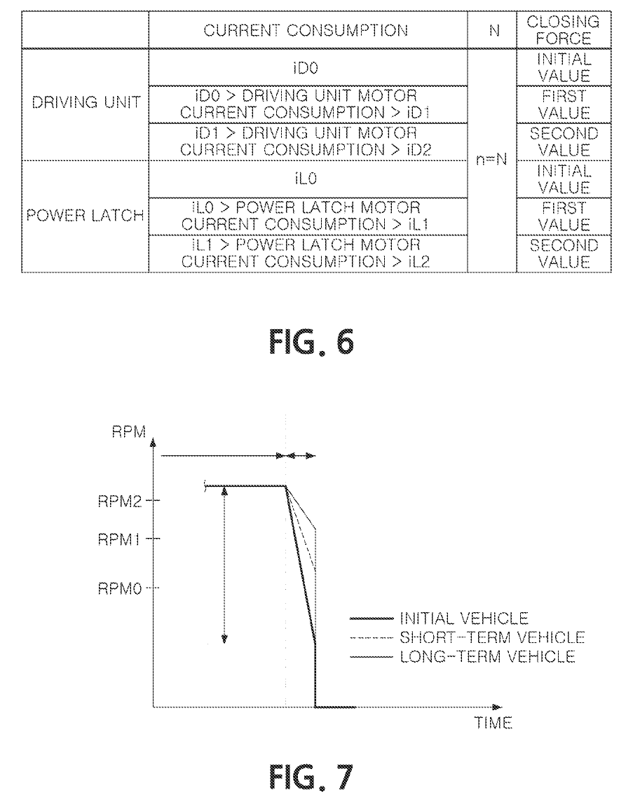

FIG. 6 is a diagram illustrating the criterion for changing closing force by the controller according to an example of the present disclosure (e.g., based on real-time current monitoring thresholds).

As illustrated in FIG. 6, the controller 10 may change the value of closing force based on the current consumption of the motor 20a of the driving unit, the current consumption of the motor 20b of the power latch, and an n value.

The current consumption of the motor 20a of the driving unit may be the maximum value among the current consumption values of the motor 20a of the driving unit detected in real time by the current detection unit 70, and here, the maximum value may be the current consumption value measured when the power latch 40 is initially locked (e.g., during primary latch engagement).

The current consumption of the motor 20b of the power latch may be the maximum value among the current consumption values of the motor 20b of the power latch detected in real time by the current detection unit 70.

iD0, iD1, and iD2 may refer to reference currents of the motor 20a of the driving unit, and iL0, iL1, and iL2 may refer to reference currents of the motor 20b of the power latch, and the unit may be ampere (A).

iD0 may be set to the maximum value among the current consumption values of the motor 20a of the driving unit measured by the current detection unit 70 of the initial vehicle described above (e.g., a newly manufactured vehicle, a demonstration vehicle, or a factory-calibrated test vehicle, etc.). The value of iD1 may be set to a value having a magnitude smaller than that of iD0 (e.g., representative of a vehicle with moderate weather strip wear or partial compression set, etc.), and the value of iD2 may be set to a value having a magnitude smaller than that of iD1 (e.g., indicative of a long-term used vehicle, a vehicle stored in extreme temperatures, or a vehicle with a degraded sealing profile, etc.).

iL0 may be set to the maximum value among the current consumption values of the motor 20b of the power latch measured by the current detection unit 70 of the initial vehicle described above (e.g., a new production vehicle, a prototype test vehicle, or a vehicle following factory inspection, etc.). The value of iL1 may be set to a value having a magnitude smaller than that of iL0 (e.g., corresponding to a vehicle with mild latch wear, partial lubrication loss, or minor alignment deviation, etc.), and the value of iL2 may be set to a value having a magnitude smaller than that of iL1 (e.g., associated with a vehicle after prolonged use, exposure to extreme weather, or latch component fatigue, etc.).

Among the current consumption values of the motor 20a of the driving unit, a section in which the maximum value is smaller than iD0 and greater than iD1 may be set to a first driving unit reference current section (e.g., a threshold current range), and a section in which the maximum value is smaller than iD1 and greater than iD2 among the current consumption values of the motor 20a of the driving unit may be set to a second driving unit reference current section (e.g., indicating reduced seal resistance).

Among the current consumption values of the motor 20b of the power latch, a section in which the maximum value is smaller than iL0 and greater than iL1 (e.g., typical for a moderately aged latch mechanism, a latch with partial seal compression, or a latch after seasonal temperature cycling, etc.) may be set to a first power latch reference current section (e.g., a threshold current range), and a section in which the maximum value is smaller than iL1 and greater than iL2 (e.g., associated with a latch after long-term wear, repeated high-load operations, or exposure to dust and moisture ingress, etc.) among the current consumption values of the motor 20b of the power latch may be set to a second power latch reference current section (e.g., a threshold current range).

n and N are natural numbers, and n may refer to the number of times the vehicle closure 50 is continuously closed as the maximum value of the current consumption value measured by the current detection unit 70 is included in the reference current section, and N may refer to a target number of times the vehicle closure 50 has to be continuously closed as the maximum value of the current consumption value measured by the current detection unit 70 is included in the reference current section. n may be a value smaller than or equal to N, and N may be pre-specified as a natural number (e.g., N = 3 consecutive closures).

As described above, the initial value of closing force may be set to a value greater than the magnitude of reaction force by the weather strip 60 (e.g., when the weather strip is new, stiffer due to cold temperature, or made of a high-durometer material, etc.). A first value may be set to a value having a magnitude of force lower than the initial value (e.g., suitable for moderately compressed seals, partially worn seals, or seals after seasonal softening, etc.), and the second value may be set to a value having a magnitude of force lower than the first value (e.g., for significantly aged seals, seals after repeated compression cycles, or seals with reduced elasticity due to material fatigue, etc.).

According to an example, when the vehicle closure 50 is located in the section 90 with reaction force due to the weather strip, in a case in which the current consumption value of the motor 20a of the driving unit at the time of initial locking of the power latch 40 measured by the current detection unit 70 is included in the first driving unit reference current section (e.g., a threshold current range) described above (e.g., indicating moderate resistance from the seal, typical for vehicles in mid-service life, etc.) and the vehicle closure 50 is closed n consecutive times, if n is the same value as N, the magnitude of closing force may be changed from the initial value to the first value by the controller 10.

In addition, when the vehicle closure 50 is located in the section 90 with reaction force due to the weather strip, in a case in which the current consumption value of the motor 20a of the driving unit at the time of initial locking of the power latch 40 measured by the current detection unit 70 is included in the second driving unit reference current section described above (e.g., suggesting minimal seal resistance, possibly due to long-term wear, environmental degradation, or low-compression design, etc.) and the vehicle closure 50 is closed n consecutive times, if n is the same value as N, the magnitude of closing force may be changed from the first value to the second value by the controller 10.

According to another example of the present disclosure, when the vehicle closure 50 is located in the section 90 with reaction force due to the weather strip, in a case in which the maximum value of the current consumption value of the motor 20b of the power latch measured by the current detection unit 70 is included in the first power latch reference current section described above (e.g., showing a moderate latch engagement load, common in average usage conditions, etc.) and the vehicle closure 50 is closed n consecutive times, if n is the same value as N, the magnitude of closing force may be changed from the initial value to the first value by the controller 10.

In addition, when the vehicle closure 50 is located in the section 90 with reaction force due to the weather strip, in a case in which the maximum value of the current consumption value of the motor 20b of the power latch measured by the current detection unit 70 is included in the second power latch reference current section described above (e.g., representing a low-load latch engagement scenario, such as in worn latch mechanisms, softened seals, or reduced preload conditions, etc.) and the vehicle closure 50 is closed n consecutive times, if n is the same value as N, the magnitude of closing force may be changed from the first value to the second value by the controller 10.

According to another example of the present disclosure, when the vehicle closure 50 is located in the section 90 with reaction force due to the weather strip, in a case in which the maximum value of the current consumption value of the motor 20a of the driving unit and the maximum value of the current consumption value of the motor 20b of the power latch measured by the current detection unit 70 are respectively included within the first driving unit reference current section and the first power latch reference current section (e.g., threshold current ranges) described above (e.g., indicating overall moderate resistance in both the closing motion and the latching step, etc.) and the vehicle closure 50 is closed n consecutive times, if n is the same value as N, the magnitude of closing force may be changed from the initial value to the first value by the controller 10.

In addition, when the vehicle closure 50 is located in the section 90 with reaction force due to the weather strip, in a case in which the maximum value of the current consumption value of the motor 20a of the driving unit and the maximum value of the current consumption value of the motor 20b of the power latch measured by the current detection unit 70 are respectively included within the second driving unit reference current section and the second power latch reference current section described above (e.g., reflecting minimal resistance in both motion and latching, possibly due to significant wear or seal deterioration, etc.) and the vehicle closure 50 is closed n consecutive times, if n is the same value as N, the magnitude of closing force may be changed from the first value to the second value by the controller 10.

When the weather strip 60 is replaced with a new product after the magnitude of closing force is changed to the first value or the second value by the controller 10, the magnitude of reaction force due to the replaced weather strip 60 may be the magnitude of reaction force due to the weather strip 60 of the initial vehicle described above. According to an example, when the weather strip 60 is replaced with a new product, the controller 10 may change the changed magnitude of closing force to the initial value (e.g., to ensure adequate sealing performance).

FIG. 7 shows an example of a change in revolutions per minute (RPM) of the motor of the driving unit according to an example of the present disclosure (e.g., when closing a trunk lid, sliding door, tailgate, or other powered vehicle closure, etc.).

In FIG. 7, the X-axis (the horizontal axis) may represent time in seconds (s). The Y-axis (the vertical axis) may represent RPM. In addition, RPM0, RPM1, and RPM2 indicated on the Y-axis (the vertical axis) may each represent a reference RPM (e.g., the highest achievable RPM for initial seal compression, a mid-range RPM for moderate resistance, or a lower RPM for soft or aged seals, etc.). The reference RPM may be a value set to define a reference RPM section.

Each graph illustrated in FIG. 7 may show that the RPM of the motor 20a of the driving unit included in the apparatus for controlling closing force of the automatic vehicle opening and closing system 100 according to an example of the present disclosure changes over time (e.g., RPM drop due to increased load, fluctuations caused by latch engagement, or variations from environmental factors such as low temperature, etc.).

A section in which the RPM changes may be the section 90 with reaction force due to the weather strip, and a section prior to entering the section in which the RPM changes may be the section 80 without reaction force due to the weather strip (e.g., when the closure moves freely without contacting seals or obstacles, etc.).

As shown in FIG. 7, when the vehicle closure 50 enters the section 90 with reaction force due to the weather strip, the RPM may gradually decrease until the power latch 40 is initially locked to overcome reaction force of the weather strip 60 and close the vehicle closure 50 (e.g., decreasing from 300 RPM to 180 RPM over 1–2 seconds, etc.). In addition, as described above, the magnitude of reaction force may decrease as the weather strip 60 is used for a long period of time, and accordingly, the change amount of RPM of the motor 20a of the driving unit to overcome reaction force of the weather strip 60 may decrease (e.g., reduced RPM drop in older seals from 120 RPM to only 40 RPM over the same time, etc.).

According to an example, when the change amount of RPM of the motor 20a of the driving unit described above is detected by an RPM detection unit (not shown) (e.g., an optical encoder, a Hall-effect sensor, or an integrated motor control chip, etc.), the apparatus for controlling closing force of the automatic vehicle opening and closing system 100 capable of changing closing force may be configured.

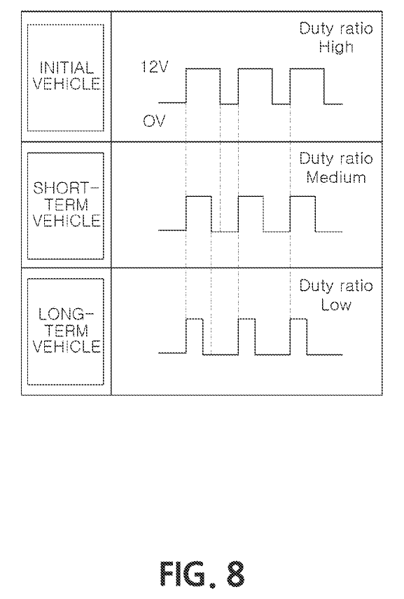

FIG. 8 shows an example of a change in duty ratio of the motor of the driving unit according to an example of the present disclosure (e.g., during different vehicle usage stages or environmental conditions such as summer heat or winter cold, etc.).

In FIG. 8, the duty ratio may refer to the ratio in which a pulse width modulation (PWM) signal is maintained in an ON state for one cycle. If the ratio of the PWM signal is in an ON state decreases and the ratio of the signal in an OFF state increases, the duty ratio may decrease (e.g., from 80% ON to 60% ON over repeated cycles, etc.).

As shown in FIG. 8, input of the motor 20a of the driving unit may be controlled such that the duty ratio of the initial usage vehicle until the initial locking of the power latch 40 is high (e.g., 85–90% ON to provide strong closing force, etc.) to overcome reaction force of the weather strip 60 and close the vehicle closure 50 within the section 90 with reaction force due to the weather strip and the duty ratio gradually decreases as the vehicle usage period increases (e.g., reduced to 65–70% ON after several years due to softened seals, etc.).

According to an example, the apparatus for controlling closing force of an automatic vehicle opening and closing system capable of changing closing force when the duty ratio of the PWM signal supplied to the motor 20a of the driving unit changes (e.g., adapting to compensate for seal stiffness, latch condition, or user preferences, etc.) may be configured.

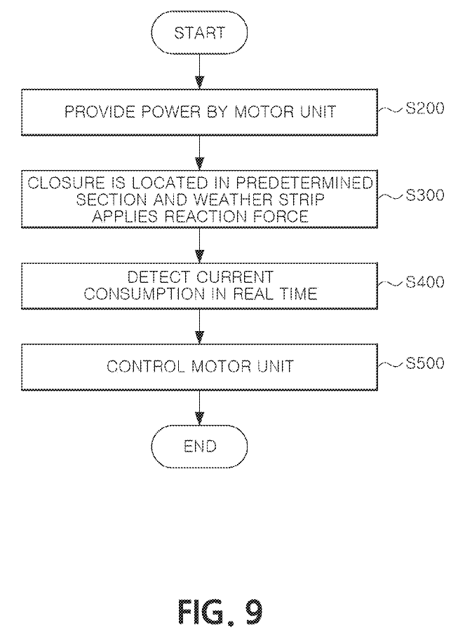

FIG. 9 shows an example of a method for controlling closing force of an automatic vehicle opening and closing system according to an example of the present disclosure (e.g., applicable to tailgates, sliding doors, trunk lids, or liftgates, etc.).

Each operation of the method for controlling closing force of the automatic vehicle opening and closing system 100 illustrated in FIG. 9 may be performed by the apparatus for controlling closing force of the automatic vehicle opening and closing system 100 described above (e.g., using the controller 10, the current detection unit 70, and the motor unit 20 working in coordination, etc.).

Referring to FIG. 9, the apparatus for controlling closing force of the automatic vehicle opening and closing system 100 according to an example may be provided with power by the motor unit 20 (S200). The power provided in operation S200 may be provided to the driving unit 30 and the power latch 40 described above with reference to FIG. 1 and may generate closing force (e.g., closing force to compress weather strips, engage latches, or overcome minor obstructions, etc.).

In addition, the apparatus for controlling closing force of the automatic vehicle opening and closing system 100 according to an example may be configured such that the vehicle closure 50 starts to be closed by power provided in operation S200 and the vehicle closure 50 may be positioned in a predetermined section so that reaction force due to the weather strip 60 may be applied to the vehicle closure 50 (S300). The operation S300 may be performed in the section 90 with reaction force due to the weather strip described above, and the predetermined section may be the section 90 with reaction force due to the weather strip (e.g., the final 5–10 cm of travel where the closure seals engage, etc.).

According to an example, current consumption of the motor unit 20 is detected in real time (S400) in the section 90 with reaction force due to the weather strip, and a change in the current consumption may be detected (e.g., an increase from 2.5 A to 3.2 A indicating seal compression, etc.). The operation S400 may be performed by the current detection unit 70 described above (e.g., using a shunt resistor or Hall-effect current sensor, etc.).

In addition, the apparatus for controlling closing force of the automatic vehicle opening and closing system 100 according to an example may determine whether the maximum value among the current consumption values of the motor 20a of the driving unit and the motor 20b of the power latch exists within the reference current section as described above according to the current consumption value detected in operation S400 and control the motor unit 20 (S500) (e.g., by reducing torque output, adjusting duty ratio, or modifying RPM, etc.). The operation S500 may be performed by the controller 10 described above.

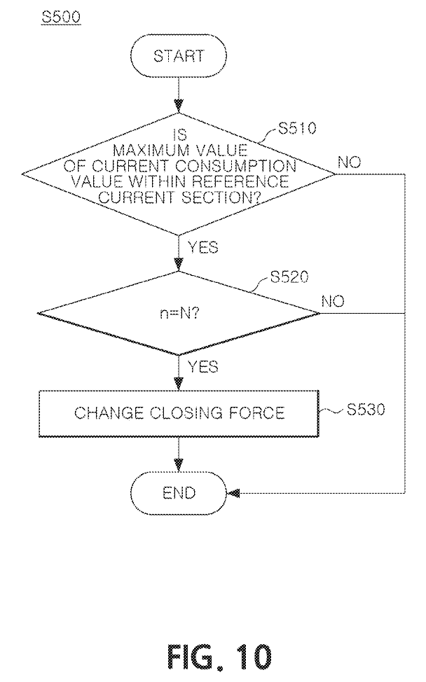

FIG. 10 shows an example of an operation of controlling a motor unit according to an example of the present disclosure (e.g., covering logic for both initial setup and adaptive adjustments during long-term use, etc.).

According to an example, it is determined whether the maximum value of the current consumption value is within the reference current section (e.g., a threshold current range)(S510). The operation S510 may be an operation of determining whether the maximum value of the current consumption value of the motor 20a of the driving unit measured in the operation S400 is included in the first driving unit reference current section and the second driving unit reference current section described above (e.g., thresholds iD1 and iD2, etc.) and may be an operation of determining whether the maximum value of the current consumption value of the motor 20b of the power latch measured in the operation S400 is included in the first power latch reference current section and the second power latch reference current section described above (e.g., thresholds iL1 and iL2, etc.).

In the operation S510, if the maximum value of the current consumption value is within the reference current section and the vehicle closure 50 is closed n times with the maximum value of the current consumption within the reference current section (e.g., 5, 10, or 15 consecutive closings, etc.), it is determined whether n has the same value as N (S520) (e.g., a preset adjustment trigger count, etc.).

If n and N have the same value, as described above, closing force may be changed to the first value having a magnitude of force lower than the initial value or to the second value having a magnitude of force lower than the first value (S530) (e.g., reducing peak force from 120 N to 90 N, or from 90 N to 70 N, etc.).

The operations S510, S520, and S530 may be performed by the controller 10 (e.g., implemented in software, firmware, or hardware circuitry, etc.).

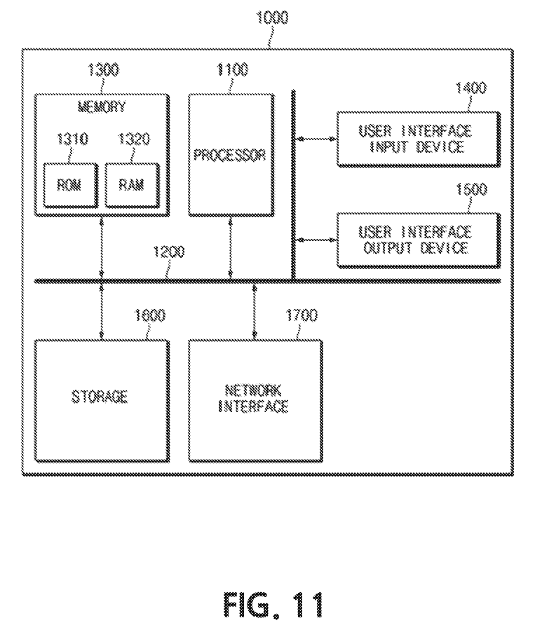

FIG. 11 shows an example computing system (e.g., a computing device of a vehicle, a closing system 100, or any other apparatus). One or more controllers, processors, etc. described herein, such as one or more components of the closing system 100, and any other components and devices disclosed herein, may be implemented by or in the computing system as shown in FIG. 11.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to an example of the present disclosure, an apparatus for controlling closing force of an automatic vehicle opening and closing system includes: a motor unit providing power to a driving unit and a power latch for opening and closing a vehicle closure; a weather strip applying reaction force in a direction opposite to a direction in which the vehicle closure is closed when the vehicle closure is located in a predetermined section; a current detection unit detecting current consumption of the motor unit in real time; and a controller controlling the motor unit so that closing force generated by the power is applied in the direction in which the vehicle closure is closed, wherein a magnitude of the closing force is changed from an initial value, and the motor unit includes a motor of the driving unit and a motor of the power latch.

When the vehicle closure is located in the predetermined section in a process in which the vehicle closure is closed N times (where N is a natural number) and a maximum value of a current consumption value of the motor of the driving unit measured in real time by the current detection unit is within a first driving unit reference current section for all N times, the controller may control the motor unit so that the magnitude of closing force is changed from the initial value to a first value, wherein the first value may have a magnitude of force lower than the initial value.

When the vehicle closure is located in the predetermined section in a process in which the vehicle closure is closed N times and the maximum value of the current consumption value of the motor of the driving unit measured in real time by the current detection unit is within a second driving unit reference current section for all N times, the controller may control the motor unit so that the magnitude of closing force is changed from the first value to a second value, wherein the second value may have a magnitude of force lower than the first value, and an upper limit value and a lower limit value of the second driving unit reference current section may have a magnitude smaller than an upper limit value and a lower limit value of the first driving unit reference current section.

When the vehicle closure is located in the predetermined section in a process in which the vehicle closure is closed N times (where N is a natural number) and a maximum value of a current consumption value of the motor of the power latch measured in real time by the current detection unit is within a first power latch reference current section for all N times, the controller may control the motor unit so that the magnitude of closing force is changed from the initial value to a first value, wherein the first value may have a magnitude of force lower than the initial value.

When the vehicle closure is located in the predetermined section in a process in which the vehicle closure is closed N times and the maximum value of the current consumption value of the motor of the power latch measured in real time by the current detection unit is within a second power latch reference current section for all N times, the controller may control the motor unit so that the magnitude of closing force is changed from the first value to a second value, wherein the second value may have a magnitude of force lower than the first value, and an upper limit value and a lower limit value of the second power latch reference current section may have a magnitude smaller than an upper limit value and a lower limit value of the first power latch reference current section.

When the vehicle closure is located in the predetermined section in a process in which the vehicle closure is closed N times (where N is a natural number) and a maximum value of a current consumption value of the motor of the driving unit measured in real time by the current detection unit and a maximum value of a current consumption value of the motor of the power latch measured in real time by the current detection unit are respectively within a first driving unit reference current section and a first power latch reference current section for all N times, the controller may control the motor unit so that the magnitude of closing force is changed from the initial value to a first value, wherein the first value may have a magnitude of force lower than the initial value.

When the vehicle closure is located in the predetermined section in a process in which the vehicle closure is closed N times and the maximum value of the current consumption value of the motor of the driving unit measured in real time by the current detection and the maximum value of the current consumption value of the motor of the power latch measured in real time by the current detection unit are respectively within a second driving unit reference current section and a second power latch reference current section for all N times, the controller may control the motor unit so that the magnitude of closing force is changed from the first value to a second value, wherein the second value may have a magnitude of force lower than the first value, and an upper limit value and a lower limit value of the second driving unit reference current section and the second power latch reference current section may have a magnitude smaller than an upper limit value and a lower limit value of the first driving unit reference current section and the first power latch reference current section.

The vehicle closure may include one or more of a door, a tailgate and a trunk of the vehicle.

The predetermined section may be a section in which the vehicle closure starts to contact the weather strip and reaction force applied by the weather strip to the vehicle closure is generated.

The controller may control the motor unit so that the magnitude of closing force is changed to the initial value when the weather strip is replaced.

According to another example of the present disclosure, a method for controlling closing force of an automatic vehicle opening and closing system includes: providing power to a driving unit and a power latch by a motor unit for opening and closing a vehicle closure; applying, by a weather strip, reaction force in a direction opposite to a direction in which the vehicle closure is closed when the vehicle closure is located in a predetermined section; detecting current consumption of the motor unit in real time; and controlling the motor unit so that closing force generated by the power is applied in the direction in which the vehicle closure is closed, wherein a magnitude of the closing force is changed from an initial value, and the motor unit includes a motor of the driving unit and a motor of the power latch.

The controlling may include controlling the motor unit so that the magnitude of closing force is changed from the initial value to a first value, when the vehicle closure is located in the predetermined section in a process in which the vehicle closure is closed N times (where N is a natural number) and a maximum value of a current consumption value of the motor of the driving unit measured in real time in the detecting of the current consumption in real time is within a first driving unit reference current section for all N times, wherein the first value may have a magnitude of force lower than the initial value.

The controlling may include controlling the motor unit so that the magnitude of closing force is changed from the first value to a second value, when the vehicle closure is located in the predetermined section in a process in which the vehicle closure is closed N times and the maximum value of the current consumption value of the motor of the driving unit measured in real time in the detecting of the current consumption in real time is within a second driving unit reference current section for all N times, wherein the second value may have a magnitude of force lower than the first value, and an upper limit value and a lower limit value of the second driving unit reference current section may have a magnitude smaller than an upper limit value and a lower limit value of the first driving unit reference current section.

The controlling may include controlling the motor unit so that the magnitude of closing force is changed from the initial value to a first value, when the vehicle closure is located in the predetermined section in a process in which the vehicle closure is closed N times (where N is a natural number) and a maximum value of a current consumption value of the motor of the power latch measured in real time in the detecting of the current consumption in real time is within a first power latch reference current section for all N times, wherein the first value may have a magnitude of force lower than the initial value.

The controlling may include controlling the motor unit so that the magnitude of closing force is changed from the first value to a second value, when the vehicle closure is located in the predetermined section in a process in which the vehicle closure is closed N times and the maximum value of the current consumption value of the motor of the power latch measured in real time in the detecting of the current consumption in real time is within a second power latch reference current section for all N times, wherein the second value may have a magnitude of force lower than the first value, and an upper limit value and a lower limit value of the second power latch reference current section may have a magnitude smaller than an upper limit value and a lower limit value of the first power latch reference current section.

The controlling may include controlling the motor unit so that the magnitude of closing force is changed from the initial value to a first value, when the vehicle closure is located in the predetermined section in a process in which the vehicle closure is closed N times (where N is a natural number) and a maximum value of a current consumption value of the motor of the driving unit measured in real time in the detecting of the current consumption in real time and a maximum value of a current consumption value of the motor of the power latch measured in real time in the detecting of the current consumption in real time are respectively within a first driving unit reference current section and a first power latch reference current section for all N times, wherein the first value may have a magnitude of force lower than the initial value.

The controlling may include controlling the motor unit so that the magnitude of closing force is changed from the first value to a second value, when the vehicle closure is located in the predetermined section in a process in which the vehicle closure is closed N times and the maximum value of the current consumption value of the motor of the driving unit measured in real time in the detecting of the current consumption in real time and the maximum value of the current consumption value of the motor of the power latch measured in real time in the detecting of the current consumption in real time are respectively within a second driving unit reference current section and a second power latch reference current section for all N times, wherein the second value may have a magnitude of force lower than the first value, and an upper limit value and a lower limit value of the second driving unit reference current section and the second power latch reference current section may have a magnitude smaller than an upper limit value and a lower limit value of the first driving unit reference current section and the first power latch reference current section.

The vehicle closure may include one or more of a door, a tailgate and a trunk of the vehicle.

The predetermined section may be a section in which the vehicle closure starts to contact the weather strip and reaction force applied by the weather strip to the vehicle closure is generated.

The method may further include: controlling the motor unit so that the magnitude of closing force is changed to the initial value when the weather strip is replaced.

The apparatus and method for controlling closing force of an automatic vehicle opening and closing system according to an example of the present disclosure may minimize human injury and improve safety performance by changing the magnitude of closing force as the magnitude of reaction force due to the weather strip changes and may automatically close the vehicle closure even if the magnitude of closing force changes by setting the magnitude of closing force larger than the magnitude of reaction force.

The effects of the present disclosure are not limited to those described above, and other effects not mentioned will be clearly recognized by those skilled in the art from the description below.

While examples have been shown and described above, it will be apparent to those skilled in the art that modifications and variations could be made without departing from the scope of the present disclosure as defined by the appended claims.

What is claimed is:

1. An apparatus of a vehicle, the apparatus comprising:
a motor assembly including a motor of a closure actuator assembly and a motor of a power latch, wherein the motor assembly is configured to provide power to the motor of the closure actuator assembly and the motor of the power latch for opening and closing a vehicle closure of the vehicle;
a weather strip configured to, based on the vehicle closure being located in a predetermined section, cause a reaction force in a direction opposite to a direction of a closing force, wherein the closing force is a force by which the vehicle closure is closed;
a current sensor configured to detect current consumption of the motor assembly in real time; and
a controller circuit configured to:
based on the detected current consumption, adjust a magnitude of the closing force from an initial value, and
control the motor assembly to apply the adjusted magnitude of the closing force in a direction in which the vehicle closure is closed.

2. The apparatus of claim 1, wherein the controller circuit is configured to control the motor assembly so that the magnitude of the closing force is changed from the initial value to a first value based on:
the vehicle closure being located in the predetermined section in a process in which the vehicle closure is closed N times, where N is a natural number, and
a maximum value of a current consumption value of the motor of the closure actuator assembly being within a first driving reference current range for N times, wherein the current consumption value of the motor of the closure actuator assembly is measured N times in real time by the current sensor, and
wherein the first value has a magnitude of force lower than the initial value.

3. The apparatus of claim 2, wherein the controller circuit is configured to control the motor assembly so that the magnitude of the closing force is changed from the first value to a second value based on:
the vehicle closure being located in the predetermined section in a process in which the vehicle closure is closed N times, and
the maximum value of the current consumption value of the motor of the closure actuator assembly being within a second driving reference current range for N times,
wherein the second value has a magnitude of force lower than the first value, and
wherein an upper limit value and a lower limit value of the second driving reference current range are smaller than an upper limit value and a lower limit value of the first driving reference current range, respectively.

4. The apparatus of claim 1, wherein the controller circuit is configured to control the motor assembly so that the magnitude of the closing force is changed from the initial value to a first value based on:
the vehicle closure being located in the predetermined section in a process in which the vehicle closure is closed N times, where N is a natural number, and
a maximum value of a current consumption value of the motor of the power latch being within a first power latch reference current range for N times, wherein the current consumption value of the motor of the power latch is measured N times in real time by the current sensor, and
wherein the first value has a magnitude of force lower than the initial value.

5. The apparatus of claim 4, wherein the controller circuit is configured to control the motor assembly so that the magnitude of the closing force is changed from the first value to a second value based on:
the vehicle closure being located in the predetermined section in a process in which the vehicle closure is closed N times, and
the maximum value of the current consumption value of the motor of the power latch being within a second power latch reference current range for N times,
wherein the second value has a magnitude of force lower than the first value, and
wherein an upper limit value and a lower limit value of the second power latch reference current range are smaller than an upper limit value and a lower limit value of the first power latch reference current range, respectively.

6. The apparatus of claim 1, wherein the controller circuit configured to control the motor assembly so that the magnitude of the closing force is changed from the initial value to a first value based on:
the vehicle closure being located in the predetermined section in a process in which the vehicle closure is closed N times, where N is a natural number,
a maximum value of a current consumption value of the motor of the closure actuator assembly being within a first driving reference current range for N times, wherein the current consumption value of the motor of the closure actuator assembly is measured N times in real time by the current sensor, and
a maximum value of a current consumption value of the motor of the power latch being within a first power latch reference current range for N times, wherein the current consumption value of the motor of the power latch is measured N times in real time by the current sensor, and
wherein the first value has a magnitude of force lower than the initial value.

7. The apparatus of claim 6, wherein the controller circuit configured to control the motor assembly so that the magnitude of the closing force is changed from the first value to a second value based on:
the vehicle closure being located in the predetermined section in a process in which the vehicle closure is closed N times,
the maximum value of the current consumption value of the motor of the closure actuator assembly being within a second driving reference current range for N times, and
the maximum value of the current consumption value of the motor of the power latch being within a second power latch reference current range for N times,
wherein the second value has a magnitude of force lower than the first value,
wherein an upper limit value and a lower limit value of the second driving reference current range are each smaller than a corresponding upper limit value and a corresponding lower limit value of the first driving reference current range, and
wherein an upper limit value and a lower limit value of the second power latch reference current range are smaller than an upper limit value and a lower limit value of the first power latch reference current range, respectively.

8. The apparatus of claim 1, wherein the vehicle closure comprises at least one of a door of the vehicle, a tailgate of the vehicle, or a trunk of the vehicle.

9. The apparatus of claim 1, wherein the predetermined section is a section in which the vehicle closure starts to contact the weather strip and the reaction force caused by the weather strip to the vehicle closure is generated.

10. The apparatus of claim 1, wherein the controller circuit is configured to control the motor assembly so that the magnitude of the closing force is changed to the initial value when the weather strip is replaced.

11. A method performed by an apparatus of a vehicle, the method comprising:
providing power to a motor of a closure actuator assembly and a motor of a power latch by a motor assembly for opening and closing a vehicle closure of the vehicle;
based on the vehicle closure being located in a predetermined section, causing, by a weather strip of the vehicle, reaction force in a direction opposite to a direction of a closing force, wherein the closing force is a force by which the vehicle closure is closed;
detecting current consumption of the motor assembly in real time;
based on the detected current consumption, adjusting a magnitude of the closing force from an initial value; and
controlling the motor assembly to apply the adjusted magnitude of the closing force in a direction in which the vehicle closure is closed.

12. The method of claim 11, wherein
the controlling of the motor assembly comprises controlling the motor assembly so that the magnitude of the closing force is changed from the initial value to a first value based on:
the vehicle closure being located in the predetermined section in a process in which the vehicle closure is closed N times, where N is a natural number, and
a maximum value of a current consumption value of the motor of the closure actuator assembly being within a first driving reference current range for N times,
wherein the current consumption value of the motor of the closure actuator assembly is measured N times in real time, and
wherein the first value has a magnitude of force lower than the initial value.

13. The method of claim 12, wherein
the controlling of the motor assembly comprises controlling the motor assembly so that the magnitude of the closing force is changed from the first value to a second value based on:
the vehicle closure being located in the predetermined section in a process in which the vehicle closure is closed N times, and
the maximum value of the current consumption value of the motor of the closure actuator assembly being within a second driving reference current range for N times,
wherein the second value has a magnitude of force lower than the first value, and
wherein an upper limit value and a lower limit value of the second driving reference current range are smaller than an upper limit value and a lower limit value of the first driving reference current range, respectively.

14. The method of claim 11, wherein
the controlling of the motor assembly comprises controlling the motor assembly so that the magnitude of the closing force is changed from the initial value to a first value based on:
the vehicle closure being located in the predetermined section in a process in which the vehicle closure is closed N times, where N is a natural number, and
a maximum value of a current consumption value of the motor of the power latch being within a first power latch reference current range for N times,
wherein the current consumption value of the motor of the power latch is measured N times in real time, and
wherein the first value has a magnitude of force lower than the initial value.

15. The method of claim 14, wherein
the controlling of the motor assembly comprises controlling the motor assembly so that the magnitude of the closing force is changed from the first value to a second value based on:
the vehicle closure being located in the predetermined section in a process in which the vehicle closure is closed N times, and
the maximum value of the current consumption value of the motor of the power latch being within a second power latch reference current range for N times,
wherein the second value has a magnitude of force lower than the first value, and
wherein an upper limit value and a lower limit value of the second power latch reference current range are smaller than an upper limit value and a lower limit value of the first power latch reference current range, respectively.

16. The method of claim 11, wherein
the controlling of the motor assembly comprises controlling the motor assembly so that the magnitude of the closing force is changed from the initial value to a first value based on:
the vehicle closure being located in the predetermined section in a process in which the vehicle closure is closed N times, where N is a natural number,
a maximum value of a current consumption value of the motor of the closure actuator assembly being within a first driving reference current range for N times, and
a maximum value of a current consumption value of the motor of the power latch being within a first power latch reference current range for N times,
wherein the current consumption value of the motor of the closure actuator assembly is measured N times in real time,
wherein the current consumption value of the motor of the power latch is measured N times in real time, and
wherein the first value has a magnitude of force lower than the initial value.

17. The method of claim 16, wherein
the controlling of the motor assembly comprises controlling the motor assembly so that the magnitude of the closing force is changed from the first value to a second value based on:
the vehicle closure being located in the predetermined section in a process in which the vehicle closure is closed N times,
the maximum value of the current consumption value of the motor of the closure actuator assembly being within a second driving reference current range for N times, and
the maximum value of the current consumption value of the motor of the power latch being within a second power latch reference current range for N times,
wherein the second value has a magnitude of force lower than the first value, and
wherein an upper limit value and a lower limit value of the second driving reference current range are smaller than an upper limit value and a lower limit value of the first driving reference current range, respectively, and
wherein an upper limit value and a lower limit value of the second power latch reference current range are smaller than an upper limit value and a lower limit value of the first power latch reference current range, respectively.

18. A vehicle comprising:
a closure panel configured to move between an open position and a closed position;
a motor configured to provide closing force for closing the closure panel;
a power latch configured to secure the closure panel in the closed position;
a weather strip configured to contact the closure panel in the closed position and cause a reaction force opposing closure of the closure panel;
a processor; and
a memory storing at least one instruction that, when executed by the processor communicating with the memory, is configured to cause the vehicle to:
detect a current level of the motor corresponding to the reaction force caused by the weather strip opposing closure of the closure panel,
determine a maximum value of the detected current level over a predetermined number of consecutive closure panel closing events,
based on the maximum value repeatedly falling within a reference current range for the predetermined number of consecutive closure panel closing events, adjust a magnitude of the closing force of the motor.

19. The vehicle of claim 18, wherein the at least one instruction, when executed by the processor communicating with the memory, is configured to cause the vehicle to determine the current level of the motor at a time of initial locking of the power latch during a closure panel closing event, and use the determined current level as the maximum value.

20. The vehicle of claim 18, wherein the at least one instruction, when executed by the processor communicating with the memory, is configured to cause the vehicle to change the magnitude of the closing force from an initial value to a first value, and from the first value to a second value lower than the first value, based on the maximum value being repeatedly within respective lower reference current ranges for the predetermined number of consecutive closure panel closing events.
